(19) United States
(12) Patent Application Publication
(10) Pub. No.: US 2007/0005912 A1
(43) Pub. Date: Jan. 4, 2007

(54) APPARATUS AND METHOD FOR REDUCING TAG RAM ACCESS

(76) Inventor: Ming-Chung Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,633

(22) Filed: Jul. 1, 2005

(51) Int. Cl. G06F 12/00

(52) U.S. Cl. 711/156

(57) ABSTRACT

An apparatus and a method for reducing TAG RAM access are provided. The apparatus includes a status recording unit and a control signal generating unit. The status recording unit compares current index data with previous index data, and records read/write status of the TAG RAMs. The control signal generating unit is coupled to the status recording unit for generating a control signal (such as a chip selecting signal) to determine whether the TAG RAMs can be accessed or not. Wherein, the control signal is enabled when the TAG RAMs is in write status, or the output of the status recording unit determines whether the control signal is disabled when the TAG RAMs is in read status.

### BACKGROUND OF THE INVENTION

1. Field of Invention

The present invention relates to a cache memory. More particularly, the present invention relates to an apparatus and a method for reducing TAG RAM access in cache memory.

2. Description of Related Art

In the structure of a computer, the cache memory is a kind of memory having a function between the central processing unit (CPU) and a main memory. In general, CPU would read data/commands from the main memory or write data/commands to the main memory, and the access addresses mostly are continuous. With the characteristic of quick access, the cache memory copies and registers a plurality of data/commands at the vicinity of the address where the CPU accesses into the cache memory. Next, once the CPU accesses the data/commands in the next address, it would search in the cache memory for the data/commands that CPU would access in the next address. If the data/commands are found, CPU can access the data/commands in the cache memory more quickly (compared with the main memory).

FIG. 1 is a schematic block diagram of the conventional cache memory. Please refer to FIG. 1. The conventional cache memory 100 has multiway data/commands RAMs (120-1 to 120-K), and the data/commands accessed from the main memory in advance would be saved in the data/commands RAMs 120-1 to 120-K in sequence. When CPU (not shown) accesses the data/commands in the next address, partial bits of the CPU index data INDEX would be searched in TAG RAM 110 to see whether there is a same tag as the index data INDEX in each way TAG RAMs (110-1 to 110-K) in TAG RAM 110. If one of the way TAG RAMs (110-1 to 110-K) saves an identical tag with the index data INDEX, the responding data/commands are accessed from the way data/commands RAM in accordance with the remaining bits of the index data INDEX.

For example, CPU index data INDEX has 16 bits. Each way data/commands can save 4 data/commands, and each way TAG RAMs (110-1 to 110-K) in TAG RAM 110 can save the data/commands within the way data/commands RAM in the corresponding address tag in the main memory. Suppose the tag saved in the first way TAG RAM 110-1 of TAG RAM has the same first 14 bits with the index data INDEX, the remaining 2 bits of the index data INDEX would decide which data/commands in the first way data/commands RAM 120-1 to access.

In general, the operation of accessing the cache memory occupies most power consumption of CPU. In a conventional design of the cache memory, as there is no sufficient information to indicate which way data/commands RAM would be accessed, all of the way TAG RAMs (110-1 to 110-K) would turn on to search the index data INDEX while accessing data/commands. However, usually there is only one way TAG RAM that saves the needed tag. Suppose there are totally N commands in one program and there are K ways data/commands RAMs and TAG RAMs, a total of N*K times in accessing TAG RAM are required in the program process. In the N*K times of accessing operation, N*(K−1) times of accessing is unnecessary, and the power is wasted.

The concept of continuous program and continuous data can be used to reduce the access of TAG RAM. That is, the continuous commands or data in the same way can be exchanged. When accessing the TAG RAM, if the next command or datum is continuous, only the RAM accessed last in the same way need to be turned on. As interruption may occur at any time, unfortunately it might be impossible to locate these continuous commands or data in RAM of the same way. In some academic research, a sequential access way predictor (SAWP) table is proposed to predict the RAM to be accessed in the next way. However, these methods require higher cost and have no prediction compensation.

### SUMMARY OF THE INVENTION

Accordingly, the present invention is directed to an apparatus and a method for reducing TAG RAM access, and further for saving power consumption.

The present invention provides an apparatus for reducing TAG RAM access, which is suitable for a cache memory with at least one TAG RAM. Wherein, index data is used in cache memory to find whether there is a same index data in TAG RAM. The apparatus for reducing TAG RAM access includes a status recording unit and a control signal generating unit. The status recording unit compares the current index data with previous index data, and records the read/write status of the TAG RAMs. The control signal generating unit is coupled to the status recording unit for generating a control signal (such as a chip selecting signal) to determine whether the TAG RAMs can be accessed or not. Wherein, the control signal is enabled when the TAG RAMs is in write status, or it is determined whether the control signal is disabled according to the output of the status recording unit when the TAG RAMs is in read status.

In the apparatus for reducing TAG RAM access according to the embodiment of the present invention, the status recording unit includes effective flag, tag index register and comparator. When the TAG RAM is in write status, the effective flag is set as ‘false’; and when the TAG RAM is in read status, the effective flag is set as ‘true’. The tag index register receives the current index data and outputs the previous index data. The comparator receives and compares the current index data with the previous index data output from the tag index register, and outputs the comparison result. Wherein, when the TAG RAM is in read status, the control signal generating unit determines whether the control signal is enabled or not according to the status of the effective flag and the comparison result of the comparator.

Accordingly to the apparatus for reducing TAG RAM access according to the embodiment of the present invention, when the control signal is disabled so that the TAG RAM can not be accessed, the output of the TAG RAM remains the previous status.

Moreover, the present invention also provides a method for reducing TAG RAM access, which is suitable for the cache memory with at least one TAG RAM and index data is used in the cache memory to search whether there is a same index data in TAG RAM. The method for reducing TAG RAM access includes the following steps: a. the TAG RAM is enabled when the TAG RAM is in write status; b. when the TAG RAM is in read status, the TAG RAM is determined whether to be enabled or not according to the comparison result of the current index data status with the previous index data status.

According to the method for reducing TAG RAM access according to the embodiment of the present invention, the above step b includes the following steps: c. when the TAG RAM is in read status, the TAG RAM is enabled if the current index data is the first index data when the TAG RAM is switched to the original read status; d. when the TAG RAM is in read status, if the current index data is not the first index data when the TAG RAM is switched to the original read status, the TAG RAM is determined to be enabled or not according to the comparison result of the current index data status with the previous index data status.

According to the method for reducing TAG RAM access in the embodiment of the present invention, the above step d includes the following steps: first, register the index data; compare the current index data with the registered previous index data. The TAG RAM is disabled if the current index data is the same as the registered previous index data. The TAG RAM is enabled if the current index data is different with the registered previous index data. Wherein, when the TAG RAM is disabled, the output of the TAG RAM remains the status before the TAG RAM is disabled.

In the present invention, as the TAG RAM is determined whether to be enabled or not according to the comparison result of the current index data status with the registered previous index data, the TAG RAM access can be reduced and further the power consumption is saved.

The above and other features of the present invention will be better understood from the following detailed description of the embodiments of the invention that is provided in combination with the accompanying drawings.

### BRIEF DESCRIPTION OF THE DRAWINGS

FIG. 1 is a schematic block diagram of a conventional cache memory.

FIG. 2 is a schematic block diagram of a cache memory for reducing TAG RAM access according to an embodiment of the present invention.

### DESCRIPTION OF EMBODIMENTS

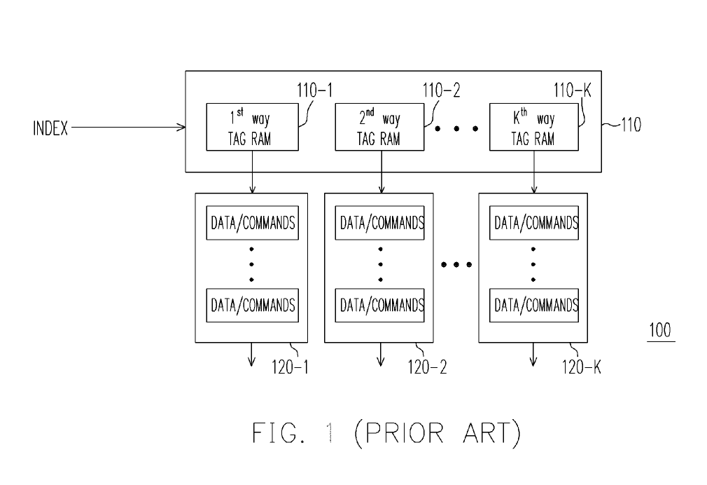

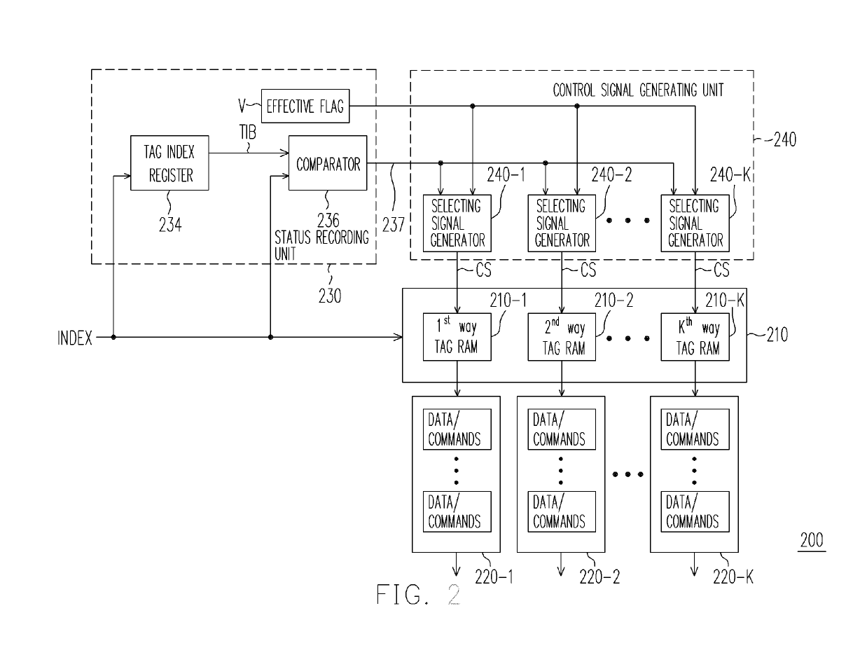

FIG. 2 is a schematic block diagram of the cache memory for reducing TAG RAM access according to an embodiment of the present invention. Pleaser refer to FIG. 2, in the cache memory 200, the operations of the TAG RAM 210 with data/commands RAMs 220-1 to 220-K can follow the operations of the TAG RAM 110 with data/commands RAMs 120-1 to 120-K in FIG. 1, so the details are not repeated here.

The TAG RAM includes every way TAG RAMs 210-1 to 210-K. The status recording unit 230 compares the current index data with the previous index data, and records the read/write status of the TAG RAMs 210-1 to 20-K. The control signal generating unit 240 is coupled to the status recording unit 230 for generating a control signal CS (such as a chip selecting signal) to determine whether the TAG RAMs 210-1 to 210-K can be accessed or not. Wherein, when the TAG RAMs 210-1 to 210-K is in write status, the control signal CS is enabled (i.e. the TAG RAMs 210-1 to 210-K is enabled); when the TAG RAMs 210-1 to 210-K is in read status, the control signal is determined whether to be enabled or not according to the output of the status recording unit 230.

In the embodiment, the status recording unit 230 may include an effective flag V, a tag index register 234 and a comparator 236, and the control signal generating unit 240 may include selecting signal generators 240-1 to 240-k. When the TAG RAMs 210-1 to 210-K is in write status or when the cache memory 200 resets, the effective flag V is set as ‘false’; when the TAG RAMs 210-1 to 210-K is in read status, the effective flag V is set as ‘true’. The tag index register 234 receives and registers the current index data and outputs the previously registered index data TIB. The comparator 236 receives and compares the current index data with the previous index data TIB output from the tag index register 234, and outputs the comparison result 237.

When the TAG RAMs 210-1 to 210-K is in write status, the control signal generating unit 240 further determines whether to enable the control signal CS or not according to the status of the effective flag V and the comparison result 237 from the comparator 236. In the embodiment, in the beginning when the TAG RAMs 210-1 to 210-K switch to the read status from write status, as the effective tag V has not turned to ‘true’ from ‘false’, the TAG RAMs 210-1 to 210-K enable the control signal CS. That is, if the current index is the first index in the beginning when the TAG RAMs 210-1 to 210-K is switched to the read status, the TAG RAMs 210-1 to 210-K is enabled to access or search whether there is a tag with the same index data INDEX in the TAG RAMs 210-1 to 210-K. Moreover, if the current index data INDEX is not the first index in the beginning when the TAG RAMs 210-1 to 210-K is switched to the read status, the TAG RAM 210-1 to 210-K is determined whether to be enabled or not according to the comparison result of the current index data INDEX with the previous index data TIB.

If the current index data INDEX is identical with the previous index data TIB output from the tag register 234 and the effective flag V is ‘true’, the tag to be accessed has been in one of the output of the TAG RAMs 210-1 to 210-K in previous access period, so that the selecting signal generators 240-1 to 240-k will disable the control signal CS, and all the TAG RAM 210-1 to 210-K are disabled (can not be accessed). Wherein, when the TAG RAM 210-1 to 210-K cannot be accessed by disabling the control signal CS, the outputs of the TAG RAM 210-1 to 210-K remain the previous status before being disabled.

In summary, the operation of the status recording unit 230 and the control signal generating unit 240 in the embodiment can be referred as the following pseudo code:

```
If (tag read) {
    CS = (V && (TIB==INDEX))? 0:1;
    Update TIB and set V to TRUE;
}
If ((tag write) {
    CS = 1;
    Set V to FALSE;
}
```

Therefore, in the cache memory 200 of the embodiment, when the TAG RAM and data/commands RAM of the same way are accessed continuously, all the TAG RAMs 210-1 to 210-K are turned on only during the first access to search the index data INDEX, then the output of the TAG RAMs 210-1 to 210-K during the first access is maintained (by disabling the chip selecting signal, for example), and the data/commands RAM of the same way can be accessed continuously without accessing the TAG RAMs 210-1 to 210-K repeatedly.

For example, considering the following program:

| COMMAND ADDRESS | COMMAND |
|---|---|
| 0x100 | I1 |
| 0x104 | I2 |
| | (I2 is branch instruction) |
| 0x200 | I3 |
| 0x204 | I4 |

In conventional cache memory with K ways, TAG RAM must be accessed 4*K times in the executing process of the above program. In the cache memory 200 of the embodiment, the TAG RAM needs only to be accessed (K+0+K+0)=(2*K) times.

Considering the following copy of the command string of loading Ld and Saving St:

| COMMAND | DATA ADDRESS |
|---|---|
| Ld1 | 0x1000 |
| St1 | 0x1000 |
| Ld2 | 0x1004 |
| St2 | 0x1004 |
| Ld3 | 0x1008 |
| St3 | 0x1008 |

According to the above embodiment, the data TAG RAM must be enabled in the process of performing each of the above command strings, and the effective flag V would be set as ‘false’ after each saving St command. Therefore, the data TAG RAM would be totally accessed 6*K times. The compiler or programmer can reduce the time of the TAG RAM access by adjusting the program execution sequence or data access sequence. For example, the program can be revised as the following:

| COMMAND | DATA ADDRESS |
|---|---|
| Ld1 | 0x1000 |
| Ld2 | 0x1004 |
| Ld3 | 0x1008 |
| St1 | 0x1000 |
| St2 | 0x1004 |
| St3 | 0x1008 |

According to the above embodiment, in the process of the above command strings, only commands Ld1, St1, St2 and St3 need to enable the data TAG RAM. Therefore, the time of the data TAG RAM access will be reduced for 4*K times.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for reducing TAG RAM access, suitable for a cache memory with at least one TAG RAM, using an index data in the cache memory to search for a same index data in TAG RAM; the apparatus for reducing TAG RAM accesses comprising:
a status recording unit, used to compare current index data with previous index data and record read/write status of the TAG RAMs; and
a control signal generating unit, used to couple the status recording unit for generating a control signal, wherein the control signal is enabled when the TAG RAMs is in write status, and an output of the status recording unit determines whether the control signal is disabled when the TAG RAMs is in read status, wherein the control signal determines whether the TAG RAMs can be accessed.

2. The apparatus for reducing TAG RAM access as claimed in claim 1, wherein the status recording unit comprises:
an effective flag, used to be set as ‘false’ when the TAG RAM is in write status, and to be set as ‘true’ when the TAG RAM is in read status;
a tag index register, used to receive the current index data and output the previous index data; and
a comparator, used to receive and compare the current index data with previous index data output from the tag index register, and output the comparison result;
wherein, when the TAG RAM is in read status, the control signal generating unit determines whether the control signal is disabled or not according to the status of the effective flag and the comparison result of the comparator.

3. The apparatus for reducing TAG RAM access as claimed in claim 1, wherein the control signal is a chip selecting signal.

4. The apparatus for reducing TAG RAM access as claimed in claim 1, wherein when the control signal is disabled so that the TAG RAM can not be accessed, the output of the TAG RAM remains the previous status.

5. A method for reducing TAG RAM access, suitable for a cache memory with at least one TAG RAM, using an index data in the cache memory to search for a same index data in TAG RAM; the method for reducing TAG RAM access comprising:
a. enabling the TAG RAM when the TAG RAM is in write status; and
b. determining whether the TAG RAM is enabled or not according to the comparison result of the current index data status with the previous index data status, when the TAG RAM is in read status.

6. The method for reducing TAG RAM access as claimed in claim 5, wherein the step b comprises:
c. when the TAG RAM is in read status, enabling the TAG RAM if the current index data is the first index data in the beginning when the TAG RAM is switched to the original read status; and
d. when the TAG RAM is in read status, determining whether to enable the TAG RAM according to the comparison result of the current index data status with the previous index data status if the current index data is not the first index data in the beginning when the TAG RAM is switched to the original read status.

7. The method for reducing TAG RAM access as claimed in claim 6, wherein the step d comprises:
registering the index data;
comparing the current index data with the registered previous index data;
disabling the TAG RAM if the current index data is the same as the registered previous index data; and
enabling the TAG RAM if the current index data is different from the registered previous index data.

8. The method for reducing TAG RAM access as claimed in claim 5, wherein when the TAG RAM is disabled, the output of the TAG RAM remains the status before the TAG RAM is disabled.
